(19) United States
(12) Patent Application Publication
(10) Pub. No.: US 2023/0285244 A1
(43) Pub. Date: Sep. 14, 2023

(54) METHOD OF TABLETING, DEVICE FOR TABLETING AND SET FOR TABLETING

(71) Applicant: Biotts Spólka Akcyjna, Bielany Wroclawskie (PL)

(72) Inventors: Pawel BIERNAT, Wroclaw (PL); Jan MELER, Smolec (PL); Dawid BURSY, Wroclaw (PL)

(73) Assignee: Biotts Spólka Akcyjna, Bielany Wroclawskie (PL)

(21) Appl. No.: 18/018,080

(22) PCT Filed: Jul. 27, 2021
(86) PCT No.: PCT/PL2021/000050

§ 371 Date: Jan. 26, 2023

(30) Foreign Application Priority Data
Jul. 27, 2020 (PL) P.434794

(51) Int. Cl. A61J 3/10; B30B 11/02; B30B 11/08

(52) U.S. Cl. CPC A61J 3/10; B30B 11/02; B30B 11/08

(57) ABSTRACT

The first object of the invention is a method of tableting a tablet mass comprising components crystallizing in a tetrahedral and/or regular system and/or subjected to micronization or nanonization, carried out in the following steps: moving the punches, filling the die cavities and/or die cavity with a tablet mass, lowering the punches and/or punch and compressing a tablet mass, pushing the tablets and/or tablet out of the die cavity, pushing the tablets and/or tablet out of the die, characterized in that the pressure in the tablet press chamber is lowered in the range from −0.005 MPa to −0.15 MPa, wherein the lowering of the pressure in the tablet press chamber reduces the pressure in the tablet press die cavity. The second object of the invention is a device for tableting a tablet mass. Another object of the invention is a kit comprising a tablet mass tableting device, as defined in the second aspect of the invention, and a vacuum pump.

The present invention relates to a method of tableting under reduced pressure and a device for carrying out the method. The invention is used in industries where it is necessary to make tablets from substances that are difficult to compress.

A process of making tablets is a key technology in making a drug form. Tablets are the most commonly used form of an oral drug. Tablets are mainly produced in a tableting process, i.e. by pressing a mixture of powders or granules. Tableting, regardless of the type of tablet press (rotary, single-punch), takes place in similar stages: moving the punches, filling a cavity with tablet mass, lowering the punches and compressing, pushing a tablet out of a cavity, pushing the tablet out of a die. Before the upper punch enters the die opening of a tablet press, the grains of the tablet mass move relative to each other in such a way that the smaller ones fill the free spaces between the larger ones, making them more accurately arranged. The distribution of grains is described by the number of contact points, which is primarily due to their size, shape, density, surface properties, and the tableting method used. For example, the theoretical free space between closely packed powder grains, characterized by the same size, is approximately 40%. Whereas, the arrangement of the spherical granule grains, such as pellets or cube-shaped grains, will be different. Then, the free space between grains can be reduced to approximately 15%. However, in practice, the arrangement of the spherical grains may be limited by the size and shape of the punches and die used. During penetration of the upper punch into a filled in die, initially only individual contact points between the grains are observed. With a further increase in the pressure force, local deformation occurs—distortion of the grains. The energy loss occurring during this process may result from friction between the powder or granules grains or from friction between the tablet side surface and the die wall. Grain deformation may be flexible, plastic or occur in the form of granularity—fragmentation. The type of deformation depends on the size of pressing force applied, its duration and also on the physical properties of the tablet mass components. If the applied compression force is lower than the yield point, the grains undergo elastic deformation, i.e. they return to their original form. As a result of increasing the pressing force, tablet mass volume reduction occurs, i.e. compression. The occurrence of plastic deformation is then observed. If the grains are brittle and breakable, fragmentation is the dominant deformation mechanism. If final distortion is reached, the potential bonding sites between the grains increase together with their deformation degree. A further compaction takes place as a result of the penetration of small grains into the spaces between the larger grains.

The second stage of compaction—consolidation—consists in combining—creating bonds between the tablet mass individual grains. The observed mutual attraction of the grains is inversely proportional to the distance between them and occurs when they are in a sufficiently close distance. This allows the grains to be continuously connected to each other.

Japanese patent application JP3141544U shows a tableting device construction, where the lower punch is lowered and raised many times during the compression stage. During each cycle of the punch movement, the compressed powder particles are agitated, which releases the air collected between the powder particles.

On the other hand, the Chinese utility model application CN207590976U discloses the construction of a tableting device in which the tableting process is carried out under vacuum conditions. The device includes a tableting chamber with a fixed die and a single movable punch. In the device, a vacuum is generated in the entire volume of the chamber in which the tableting process takes place.

The construction of a tableting device is known from the international patent application WO08087223A1. The device comprises a body to which a transparent housing is attached. In the front part of the machine body there is an eccentric mechanism driving the upper punch, a tableting die and a fixed lower punch. The front part of the body, with punches, is sealingly encased with a transparent housing which includes a flexible sleeve for handling compressed material, inert gas connection inlets, a valveless connection to a vacuum pump to generate reduced pressure during the tableting process.

US patent application US2005147710A describes a method and construction of a device for tableting a substance in a hydroxypropyl methylcellulose (HPMC) coating. The tableting device includes two movable punches, an upper and a lower punch. The lower punch is constructed in such a way that channels are hollowed therein through which a reduced pressure is generated. The tableting process is carried out in such a way that a layer of HPMC is applied to the lower punch, and then a reduced pressure is created in the lower punch. This reduces the volume of the HMPC layer. In the next step, the powder is applied to the thus obtained HPMC layer and it is pressed. The lower punch is raised up, where the second layer of HPMC has been previously applied to the die. The effect is to complete the tablet coating layer with HPMC.

The prior art, despite describing tableting devices under reduced pressure, or under vacuum conditions, and tableting method with these devices, does not show how the tableting process can be performed for substances constituting granulate or tablet mass that crystallize in crystallographic systems such as e.g. regular or tetrahedral or have been subjected to a micronization or nanonization process before tableting without additional binding substances for the tablet granulate particles. Compression of this type crystallites is difficult due to the adsorbed air on their surface, which leads to an increased friction force between the crystallites and an increased surface tension, which effectively reduces the number of contact points between the components of the tableting mass.

The technical problem faced by the invention would therefore be to provide a tableting method that would allow for the reduction of friction between the components of the tableting mass without additional glidants, containing crystallizing substances in a tetrahedral or regular arrangement, micronized or nanonized, reducing the surface tension between them, and where an initial granulation of the tablet mass would not be necessary, and it would be possible to reduce the excipient content, the method should also enable the tablet thickness to be changed without the need for additional operations. Another technical problem would be to provide a tableting device implementing this method.

The first subject of the invention is a method of tableting a tablet mass containing components crystallizing in a tetrahedral and/or regular arrangement and/or subjected to micronization and/or nanonization, carried out in the following steps:
a) moving the punch and/or punches,
b) filling the cavity and/or die cavity with a tablet mass,
c) lowering the punches and/or punch and compressing a tablet mass,
d) pushing the tablets and/or tablet out of the die cavity,
e) pushing the tablets and/or tablet out of the die
   characterized in that in steps b) and c) the pressure in the vacuum chamber is reduced in the range from −0.005 MPa to −0.15 MPa, wherein the lowering of the pressure in the vacuum chamber reduces the pressure in the tablet press die cavity.

In a preferred embodiment of the invention, in steps b) and c) the pressure in the vacuum chamber of the external tablet press is reduced.

In a further preferred embodiment of the invention the tablet press is selected from the group including: a single-punch tablet press or a rotary tablet press.

In another preferred embodiment of the invention, the tableting mass is selected from the group comprising: polysaccharide, preferably microcrystalline microcellulose, natural silica, preferably diatomaceous earth, crystalline active substance, preferably diosmin or micronized diosmin, vitamin preparation, preferably vitamin D3 coated with hydroxyapatite.

In a further preferred embodiment of the invention, the tablets have a thickness from 2.2 mm to 8.1 mm.

In yet another preferred embodiment of the invention, the pressure is reduced from −0.01 MPa to −0.15 MPa.

The second object of the invention is a tablet mass tableting device comprising a housing and a tableting mechanism, wherein the housing has a bottom wall, a top wall and four side walls that are connected to each other to form a sealed vacuum chamber, and the tableting mechanism is housed in the chamber housing, characterized in that a valve for connecting a vacuum pump is provided on the vacuum chamber side wall.

In a preferred embodiment, the tableting mechanism is a single-punch tablet press or a rotary tablet press.

In a further preferred embodiment of the invention, the chamber with the tableting mechanism is placed in the outer chamber to which a vacuum pump is connected via a vacuum valve in order to reduce the pressure.

In another advantageous embodiment of the invention, the vacuum chamber comprises a lower punch table on which a lower punch is placed, and the chamber contains a tablet press die, wherein the die is located above the lower punch and includes a die cavity for introducing the upper punch in order to introduce a tablet mass therein and to receive the upper punch.

In another preferred embodiment of the invention, the vacuum chamber top wall comprises a die of a single-punch tablet press.

In a further preferred embodiment of the invention, the chamber with the tableting mechanism, which is a single-punch tablet press, is placed in an external vacuum chamber which includes a vacuum valve for connecting a vacuum pump.

In yet another preferred embodiment of the invention, the external vacuum chamber comprises a rotary tablet press having a rotary tablet press base placed on the lower wall of the external vacuum chamber connected to a drive motor and connected to the table by the rotary tablet press rotary die, above which the rotary tablet press upper punch is placed.

Another object of the invention is a kit comprising a device for tableting a tablet mass, as defined in the second aspect of the invention and a vacuum pump which is connected to the device via a vacuum valve.

In a preferred embodiment of the invention, the device is placed in the external vacuum chamber and a vacuum pump is connected to the external chamber via vacuum valve.

According to the method described in the invention, it is possible to directly make tablets from substances crystallizing in a tetrahedral and/or regular arrangement, e.g. argentum nitricum (AgNO₃) and/or subjected to micronization or nanonization. Moreover, the solution according to the invention enables tableting of all types of substances with a reduced proportion of excipients and with the omission of granulation process.

Embodiments of the invention have been illustrated in the drawing, which shows

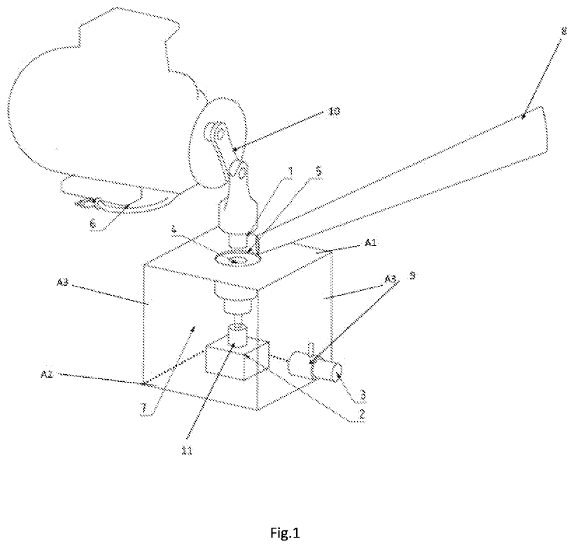

in FIG. 1 the device construction with the possibility of reducing the pressure in the chamber containing a single-punch tablet press,

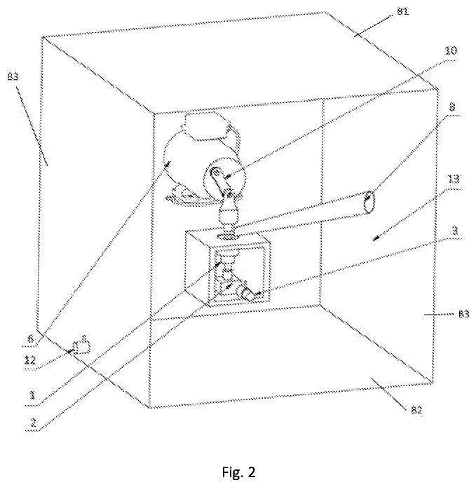

in FIG. 2 the device construction with the possibility of reducing the pressure in the vicinity of a single-punch tablet press,

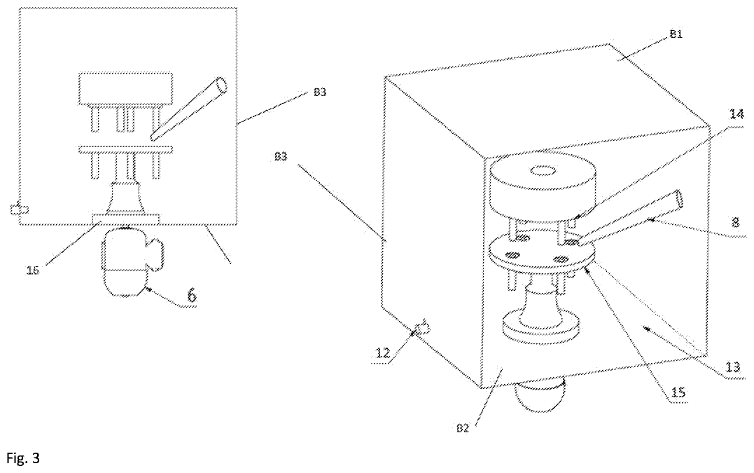

in FIG. 3 the device construction with the possibility of reducing the pressure in the vicinity of a rotary tablet press.

### EXAMPLE 1 TABLETING METHOD

The vacuum chamber 7 or 13 comprises a tableting mechanism which may be a single-punch tablet press or a rotary tablet press. In the case of single-punch tablet press, it can first be placed in the vacuum chamber 7, and then placed together with the vacuum chamber 7 in the external vacuum chamber 13. Thereafter, the tableting mass is introduced into the tablet press cavity from the hopper 8 and the pressure is lowered, in chamber 7 or chambers 7 and 13, so as to achieve the desired tablet thickness in the range from −0.005 MPa to −0.15 MPa and the tablet mass is compressed. Examples of obtaining different tablet thickness are shown in the following embodiments. The compressed tablet is then ejected from the tablet press die cavity. The process can be carried out in a single-punch tablet press (FIG. 1 or FIG. 2) and a rotary tablet press (FIG. 3). As a consequence, when the upper punch enters the filled in die, increased contact points between the granulate grains are observed. The exhausted air leads to a reduction in the number of places where the surface tension is reduced, thanks to which the contact of the grafted material is much greater. With a further increase of the upper punch pressure force, increased deformation occurs—grains distortion. The energy loss occurring during this process will be lower than in the traditional process. This is due to the reduction of the frictional forces between the grains of the powder or granules or the friction between the side surface of the tablet and the die wall. Additionally, the reduction of the friction force results from the reduced amount of air in the tablet die chamber (4, 15), i.e. from the smaller amount of air particles adsorbed on the surface of the granulate or tablet mass.

### EXAMPLE 2 TABLETING DEVICE (TABLET PRESS CHAMBER CONSTRUCTION)—SINGLE-PUNCH TABLET PRESS (FIG. 1)

In the vacuum chamber 7 formed by a housing comprising a top wall A1, a bottom wall A2 and side walls A3, there is a tableting mechanism including the tablet press table 2. The tableting mechanism may be selected from a single-punch tablet press or a rotary tablet press. The chamber 7 may be of any construction. It is important, however, that there is enough space for the tableting mechanism and that it is possible to maintain constant pressure in it during the tableting process of the tablet mass. The schematic drawing (FIG. 1) shows a cube-shaped chamber 7, in the upper wall A1 of which the die 5 of a single-punch tablet press tableting mechanism is placed. The tableting mechanism comprises a drive motor 6, eccentrically connected to a movable upper punch 1, die 5 of a tablet press which includes a tablet press cavity 4. Below the cavity 4 there is a fixed lower punch 11, which is seated on the table 2. The tableting mass is fed into the die chamber 4 from a movable hopper 8. And a vacuum pump is connected to the chamber 7 through valve 9 to create a reduced pressure in the chamber 7.

Another possibility is to place the single-punch tablet press as described above in an additional outer chamber 13, which is also connected to a vacuum pump, not shown in FIG. 2, for clarity, by means of a connection valve 12 located on one of the side walls. The chamber 13 comprises, like the chamber 7, a top wall B1, a bottom wall B2 and side walls B3.

### EXAMPLE 3 TABLETING DEVICE (TABLET PRESS CHAMBER CONSTRUCTION)—A ROTARY TABLET PRESS, FIG. 3

The tableting mechanism, which is a rotary tablet press, is housed in the vacuum chamber 13, in which a reduced pressure/vacuum is produced by means of a vacuum pump, not shown in FIG. 3, for clarity, and connected via valve 12. Wherein, in chamber 13 there is only the tablet press mechanism and drive unit—the tablet press motor 6 is placed outside it. The connecting method of motor 6 with the tablet press mechanism in order to ensure the tightness of the vacuum chamber 13 will be obvious to a person skilled in the field of mechanics.

### EXAMPLE 4 TABLETS COMPRESSED IN A SINGLE-PUNCH TABLET PRESS—REDUCED PRESSURE GENERATED IN THE TABLET PRESS CHAMBER (FIG. 1)

The compression of the tablets was performed under reduced pressure conditions in the tablet press chamber of a single-punch type. For this purpose, a vacuum pump was connected to the sealed lower chamber covering the elements regulating the lower punch and the elements fixing the table and the fixed die. The output pressure on the pump was set in various ranges (0-0.15 MPa). Tableting under standard conditions (atmospheric pressure) was considered a control test.

a) Microcrystalline cellulose was used as a model substance for the first test. The die 5 and punches 1 and 11, matched to it, were used to carry out the tests. The weight of the tablet substance in the die was 1 g.

As a result of the tests, the following results were obtained:

TABLE 1
The results of tests with microcrystalline cellulose

| Outlet pressure | | Average thickness | |
|---|---|---|---|
| on the vacuum | | of the obtained | |
| pump manometer | | tablet [mm] | Observations |
| 0 MPa | | 6.57 | A positive result tablet does |
| (atmospheric | | | not disintegrate |
| pressure) | | | |
| 0.005 | MPa | 5.84 | A positive result tablet does |
| | | | not disintegrate |
| 0.01 | MPa | 5.61 | A positive result tablet does |
| | | | not disintegrate |
| 0.05 | MPa | 5.19 | A positive result tablet does |
| | | | not disintegrate |
| 0.1 | MPa | 5.04 | A positive result tablet does |
| | | | not disintegrate |
| 0.15 | MPa | 4.87 | A positive result tablet does |
| | | | not disintegrate |

The result of the experiment was the observation of the relationship between the value of the output pressure observed on the vacuum pump manometer and the thickness of the obtained tablet. The higher the starting pressure, the smaller the measured average thickness of the end product observed.

b) For the second test, diatomaceous earth (silica of natural origin—SiO₂) was used as a model substance. Weight of the tableting substance in the die was 1 g. The die 5 and punches 1 and 11, matched to it, were used to carry out the tests. The obtained results are presented in Table 2.

TABLE 2
The results of tests with diatomaceous earth

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 8.54 | A negative result The tablet |
| | | | is capped or disintegrates |
| 0.01 | MPa | 7.56 | A positive result tablet does |
| | | | not disintegrate |
| 0.05 | MPa | 6.93 | A positive result tablet does |
| | | | not disintegrate |
| 0.1 | MPa | 6.32 | A positive result tablet does |
| | | | not disintegrate |
| 0.15 | MPa | 5.94 | A positive result tablet does |
| | | | not disintegrate |

As a result of the experiment, tablets were obtained from a substance that cannot be compressed under atmospheric pressure.

Another positive effect of the experiment was the observation of the relationship between the value of the output pressure observed on the vacuum pump manometer and the thickness of the obtained tablet, the effects of which confirm the observations from the first test with the first model substance (microcrystalline cellulose). The higher the starting pressure, the smaller the measured average thickness of the end product observed.

c) For the third test, diosmin was used as a test substance. The weight of the tablet substance in die 5 was 1 g. The obtained results are shown in Table 3.

TABLE 3
The results of tests with diosmin

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 7.62 | A negative result The tablet |
| | | | is capped or disintegrates |
| 0.01 | MPa | 7.16 | A positive result tablet does |
| | | | not disintegrate |
| 0.05 | MPa | 6.57 | A positive result tablet does |
| | | | not disintegrate |
| 0.1 | MPa | 6.21 | A positive result tablet does |
| | | | not disintegrate |
| 0.15 | MPa | 5.98 | A positive result tablet does |
| | | | not disintegrate |

As a result of the experiment, tablets were obtained from a substance that cannot be subjected to a tableting process under atmospheric pressure.

An additional positive effect of the experiment, as in the first two cases, was the observation of the relationship between the value of the output pressure observed on the vacuum pump manometer and the thickness of the obtained tablet. The higher the starting pressure, the smaller the measured average thickness of the end product observed.

d) For the fourth test, microcrystalline cellulose was used as a model substance. The die 5 and the punches 1 and 11, matched to it, were used to carry out the tests. As a result of the tests, the following results were obtained:

TABLE 4
The results of tests with microcrystalline cellulose

| Outlet pressure | | Average thickness | |
|---|---|---|---|
| on the vacuum | | of the obtained | |
| pump manometer | | tablet [mm] | Observations |
| 0 MPa | | 3.85 | A positive result tablet does |
| (atmospheric | | | not disintegrate |
| pressure) | | | |
| 0.005 | MPa | 3.32 | A positive result tablet does |
| | | | not disintegrate |
| 0.01 | MPa | 3.01 | A positive result tablet does |
| | | | not disintegrate |
| 0.05 | MPa | 2.86 | A positive result tablet does |
| | | | not disintegrate |
| 0.1 | MPa | 2.52 | A positive result tablet does |
| | | | not disintegrate |
| 0.15 | MPa | 2.45 | A positive result tablet does |
| | | | not disintegrate |

The result of the experiment was the observation of the relationship between the value of the output pressure observed on the vacuum pump manometer and the thickness of the obtained tablet. The higher the starting pressure, the smaller the measured average thickness of the end product observed.

f) For the fifth test, diatomaceous earth (silica of natural origin—SiO₂) was used as a model substance. The die 5 and the punches 1 and 11, matched to it, were used to carry out the tests. The obtained results are shown in Table 5.

TABLE 5
The results of tests with diatomaceous earth

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 3.82 | A negative result The tablet |
| | | | is capped or disintegrates |
| 0.01 | MPa | 3.64 | A positive result tablet does |
| | | | not disintegrate |
| 0.05 | MPa | 3.53 | A positive result tablet does |
| | | | not disintegrate |
| 0.1 | MPa | 3.41 | A positive result tablet does |
| | | | not disintegrate |
| 0.15 | MPa | 3.29 | A positive result tablet does |
| | | | not disintegrate |

As a result of the experiment, tablets were obtained from a substance that cannot be compressed under atmospheric pressure.

Another positive effect of the experiment was the observation of the relationship between the value of the output pressure observed on the vacuum pump manometer and the thickness of the obtained tablet, the effect of which confirm the observations from the first test with the first model substance (microcrystalline cellulose). The higher the starting pressure, the smaller the measured average thickness of the end product observed.

g) For the sixth test, micronized diosmin was used as a test substance. The die 5 and the punches 1 and 11, matched to it, were used to carry out the tests. The obtained results are shown in Table 6.

TABLE 6
The results of tests with micronized diosmin

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 3.82 | A negative result The tablet |
| | | | is capped or disintegrates |
| 0.01 | MPa | 3.64 | A positive result tablet does |
| | | | not disintegrate |
| 0.05 | MPa | 3.53 | A positive result tablet does |
| | | | not disintegrate |
| 0.1 | MPa | 3.41 | A positive result tablet does |
| | | | not disintegrate |
| 0.15 | MPa | 3.29 | A positive result tablet does |
| | | | not disintegrate |

As a result of the experiment, tablets were obtained from a substance that cannot be subjected to a tableting process under atmospheric pressure.

An additional positive effect of the experiment, as in the first two cases, was the observation of the relationship between the value of the output pressure observed on the vacuum pump manometer and the thickness of the obtained tablet. The higher the starting pressure, the smaller the measured average thickness of the end product observed.

h) For the seventh test, vitamin D3 precoated with hydroxyapatite in a weight ratio of 1:87 plus excipients was used as a test substance. The die 5 and the punches 1 and 11, matched to it, were used to carry out the tests. The obtained results are shown in Table 7.

TABLE 7
The results of tests with vitamin D3 precoated with hydroxyapatite
in a weight ratio of 1:87 plus excipients

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 8.11 | A negative result The tablet |
| | | | is capped or disintegrates |
| 0.01 | MPa | 8.02 | A positive result tablet does |
| | | | not disintegrate |
| 0.05 | MPa | 7.91 | A positive result tablet does |
| | | | not disintegrate |
| 0.1 | MPa | 7.76 | A positive result tablet does |
| | | | not disintegrate |
| 0.15 | MPa | 7.45 | A positive result tablet does |
| | | | not disintegrate |

As a result of the experiment, tablets were obtained from a mixture that cannot be subjected to a tableting process under atmospheric pressure.

An additional positive effect of the experiment, as in the first two cases, was the observation of the relationship between the value of the output pressure observed on the vacuum pump manometer and the thickness of the obtained tablet. The higher the starting pressure, the smaller the measured average thickness of the end product observed.

### EXAMPLE 5 TABLETS COMPRESSED ON A SINGLE-PUNCH TABLET PRESS—REDUCED PRESSURE GENERATED AROUND THE TABLE PRESS OF A SINGLE-PUNCH TYPE, FIG. 2

For this purpose, the entire device was placed in a sealed chamber to which a vacuum pump was connected. The output pressure on the pump was set in various ranges (0-0.15 MPa). Tableting under standard conditions (atmospheric pressure) was considered a control test.

a) For the first test, microcrystalline cellulose was used as a model substance. The die 5 and the punches 1 and 11, matched to it, were used to carry out the tests. The weight of the tableting substance in the die was 1 g. As a result of the tests, the following results were obtained:

TABLE 8
The results of tests with microcrystalline cellulose

| Outlet pressure | | Average thickness | |
|---|---|---|---|
| on the vacuum | | of the obtained | |
| pump manometer | | tablet [mm] | Observations |
| 0 MPa | | 6.61 | A positive result tablet does |
| (atmospheric | | | not disintegrate |
| pressure) | | | |
| 0.005 | MPa | 5.79 | A positive result tablet does |
| | | | not disintegrate |
| 0.01 | MPa | 5.63 | A positive result tablet does |
| | | | not disintegrate |
| 0.05 | MPa | 5.12 | A positive result tablet does |
| | | | not disintegrate |
| 0.1 | MPa | 4.91 | A positive result tablet does |
| | | | not disintegrate |
| 0.15 | MPa | 4.85 | A positive result tablet does |
| | | | not disintegrate |

The result of the experiment was the observation of the relationship between the value of the output pressure observed on the vacuum pump manometer and the thickness of the obtained tablet. The higher the starting pressure, the smaller the measured average thickness of the end product observed.

b) For the second test, diatomaceous earth (silica of natural origin—SiO2) was used as a model substance. The weight of the tableting substance in the die was 1 g. The die 5 and the punches 1 and 11, matched to it, were used to carry out the tests. The obtained results are shown in Table 9.

TABLE 9
The results of tests with diatomaceous earth

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 8.41 | A negative result The tablet |
| | | | is capped or disintegrates |
| 0.01 | MPa | 7.87 | A positive result tablet does |
| | | | not disintegrate |
| 0.05 | MPa | 7.11 | A positive result tablet does |
| | | | not disintegrate |
| 0.1 | MPa | 6.62 | A positive result tablet does |
| | | | not disintegrate |
| 0.15 | MPa | 6.34 | A positive result tablet does |
| | | | not disintegrate |

As a result of the experiment, tablets were obtained from a substance that cannot be compressed under atmospheric pressure.

Another positive effect of the experiment was the observation of the relationship between the value of the output pressure observed on the vacuum pump manometer and the thickness of the obtained tablet, the effect of which confirm the observations from the first test with the first model substance (microcrystalline cellulose). The higher the starting pressure, the smaller the measured average thickness of the end product observed.

c) For the third test, diosmin was used as a test substance. The weight of the tableting substance in the die was 1 g. The obtained results are shown in Table 10.

TABLE 10
The results of tests with diosmin

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 7.74 | A negative result The tablet |
| | | | is capped or disintegrates |
| 0.01 | MPa | 7.17 | A positive result tablet does |
| | | | not disintegrate |
| 0.05 | MPa | 6.69 | A positive result tablet does |
| | | | not disintegrate |
| 0.1 | MPa | 6.18 | A positive result tablet does |
| | | | not disintegrate |
| 0.15 | MPa | 5.95 | A positive result tablet does |
| | | | not disintegrate |

As a result of the experiment, tablets were obtained from a substance that cannot be subjected to the tableting process under atmospheric pressure.

An additional positive effect of the experiment, as in the first two cases, was the observation of the relationship between the value of the output pressure observed on the vacuum pump manometer and the thickness of the obtained tablet. The higher the starting pressure, the smaller the measured average thickness of the end product observed.

d) For the fourth test, microcrystalline cellulose was used as a model substance. The die 5 and the punches 1 and 11, matched to it, were used to carry out the tests. As a result of the tests, the following results were obtained:

TABLE 11
The results of tests with microcrystalline cellulose

| Outlet pressure | | Average thickness | |
|---|---|---|---|
| on the vacuum | | of the obtained | |
| pump manometer | | tablet [mm] | Observations |
| 0 MPa | | 3.83 | A positive result tablet does |
| (atmospheric | | | not disintegrate |
| pressure) | | | |
| 0.005 | MPa | 3.27 | A positive result tablet does |
| | | | not disintegrate |
| 0.01 | MPa | 3.06 | A positive result tablet does |
| | | | not disintegrate |
| 0.05 | MPa | 2.74 | A positive result tablet does |
| | | | not disintegrate |
| 0.1 | MPa | 2.37 | A positive result tablet does |
| | | | not disintegrate |
| 0.15 | MPa | 2.21 | A positive result tablet does |
| | | | not disintegrate |

The result of the experiment was the observation of the relationship between the value of the output pressure observed on the vacuum pump manometer and the thickness of the obtained tablet. The higher the starting pressure, the smaller the measured average thickness of the end product observed.

e) For the fifth test, diatomaceous earth (silica of natural origin—SiO2) was used as a model substance. The die 5 and the punches 1 and 11, matched to it, were used to carry out the tests. The obtained results are shown in Table 12.

TABLE 12
The results of tests with diatomaceous earth

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 3.74 | A negative result The tablet |
| | | | is capped or disintegrates |
| 0.01 | MPa | 3.49 | A positive result tablet does |
| | | | not disintegrate |
| 0.05 | MPa | 3.37 | A positive result tablet does |
| | | | not disintegrate |
| 0.1 | MPa | 3.21 | A positive result tablet does |
| | | | not disintegrate |
| 0.15 | MPa | 3.17 | A positive result tablet does |
| | | | not disintegrate |

As a result of the experiment, tablets were obtained from a substance that cannot be compressed under atmospheric pressure.

Another positive effect of the experiment was the observation of the relationship between the value of the output pressure observed on the vacuum pump manometer and the thickness of the obtained tablet, the effects of which confirm the observations from the first test with the first model substance (microcrystalline cellulose). The higher the starting pressure, the smaller the measured average thickness of the end product observed.

g) For the sixth test, micronized diosmin was used as a model substance. The die 5 and the punches 1 and 11, matched to it, were used to carry out the tests. The obtained results are shown in Table 13.

TABLE 13
The results of tests with micronized diosmin

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 3.80 | A negative result The tablet |
| | | | is capped or disintegrates |
| 0.01 | MPa | 3.67 | A positive result tablet does |
| | | | not disintegrate |
| 0.05 | MPa | 3.51 | A positive result tablet does |
| | | | not disintegrate |
| 0.1 | MPa | 3.46 | A positive result tablet does |
| | | | not disintegrate |
| 0.15 | MPa | 3.28 | A positive result tablet does |
| | | | not disintegrate |

As a result of the experiment, tablets were obtained from a substance that cannot be subjected to the tableting process under atmospheric pressure.

An additional positive effect of the experiment, as in the first two cases, was the observation of the relationship between the value of the output pressure observed on the pressure pump manometer and the thickness of the obtained tablet. The higher the starting pressure, the smaller the measured average thickness of the end product observed.

h) For the seventh test, vitamin D3 precoated with hydroxyapatite in a weight ratio of 1:87 plus excipients was used as a test substance. The die 5 and the punches 1 and 11, matched to it, were used to carry out the tests. The obtained results are shown in Table 14.

TABLE 14
The results of tests with vitamin D3 precoated with hydroxyapatite
in a weight ratio of 1:87 plus excipients

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 8.19 | A negative result The tablet |
| | | | is capped or disintegrates |
| 0.01 | MPa | 8.06 | A positive result tablet does |
| | | | not disintegrate |
| 0.05 | MPa | 7.86 | A positive result tablet does |
| | | | not disintegrate |
| 0.1 | MPa | 7.68 | A positive result tablet does |
| | | | not disintegrate |
| 0.15 | MPa | 7.51 | A positive result tablet does |
| | | | not disintegrate |

As a result of the experiment, tablets were obtained from a mixture that cannot be subjected to the tableting process under atmospheric pressure.

An additional positive effect of the experiment, as in the first two cases, was the observation of the relationship between the value of the output pressure observed on the vacuum pump manometer and the thickness of the obtained tablet. The higher the starting pressure, the smaller the measured average thickness of the end product observed.

### EXAMPLE 6 TABLETS COMPRESSED IN A ROTARY TABLET PRESS—REDUCED PRESSURE GENERATED AROUND THE TABLET PRESS OF A ROTARY TYPE, FIG. 3

For this purpose, a vacuum pump was connected to a sealed chamber built around movable parts—die, punches. The output pressure on the pump was set in various ranges (0-015 MPa). Tableting under standard conditions (atmospheric pressure) was considered a control test.

a) For the first test, microcrystalline cellulose was used as a model substance. The die 15 and the punch 14, matched to it, were used to carry out the tests. The weight of the tableting substance in the die was 1 g. As a result of the tests, the following results were obtained:

TABLE 15
The results of tests with microcrystalline cellulose

| Outlet pressure | | Average thickness | |
|---|---|---|---|
| on the vacuum | | of the obtained | |
| pump manometer | | tablet [mm] | Observations |
| 0 MPa | | 6.62 | A positive result tablet does |
| (atmospheric | | | not disintegrate |
| pressure) | | | |
| 0.005 | MPa | 6.12 | A positive result tablet does |
| | | | not disintegrate |
| 0.01 | MPa | 5.71 | A positive result tablet does |
| | | | not disintegrate |
| 0.05 | MPa | 5.14 | A positive result tablet does |
| | | | not disintegrate |
| 0.1 | MPa | 4.96 | A positive result tablet does |
| | | | not disintegrate |
| 0.15 | MPa | 4.82 | A positive result tablet does |
| | | | not disintegrate |

The result of the experiment was the observation of the relationship between the value of the output pressure observed on the vacuum pump manometer and the thickness of the obtained tablet. The higher the starting pressure, the smaller the measured average thickness of the end product observed.

b) For the second test, diatomaceous earth (silica of natural origin—SiO2) was used as a model substance. Weight of the tableting substance in the die was 1 g. The die 15 and the punch 14, matched to it, were used to carry out the tests. The obtained results are shown in Table 16.

TABLE 16
The results of tests with diatomaceous earth

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 8.61 | A negative result The tablet |
| | | | is capped or disintegrates |
| 0.01 | MPa | 7.74 | A positive result tablet does |
| | | | not disintegrate |
| 0.05 | MPa | 6.87 | A positive result tablet does |
| | | | not disintegrate |
| 0.1 | MPa | 6.29 | A positive result tablet does |
| | | | not disintegrate |
| 0.15 | MPa | 5.97 | A positive result tablet does |
| | | | not disintegrate |

As a result of the experiment, tablets were obtained from a substance that cannot be compressed under atmospheric pressure.

Another positive effect of the experiment was the observation of the relationship between the value of the output pressure observed on the vacuum pump manometer and the thickness of the obtained tablet, the effects of which confirm the observations from the first test with the first model (microcrystalline cellulose). The higher the starting pressure, the smaller the measured average thickness of the end product observed.

c) For the third test, diosmin was used as a test substance. The weight of the tablet substance id the die was 1 g. The obtained results are shown in Table 17.

TABLE 17
The results of tests with diosmin

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 7.63 | A negative result The tablet |
| | | | is capped or disintegrates |
| 0.01 | MPa | 7.18 | A positive result tablet does |
| | | | not disintegrate |
| 0.05 | MPa | 6.49 | A positive result tablet does |
| | | | not disintegrate |
| 0.1 | MPa | 6.24 | A positive result tablet does |
| | | | not disintegrate |
| 0.15 | MPa | 6.01 | A positive result tablet does |
| | | | not disintegrate |

As a result of the experiment, tablets were obtained from a substance that cannot be subjected to the tableting process under atmospheric pressure.

An additional positive effect of the experiment, as in the first two cases, was the observation of the relationship between the value of the output pressure observed on the vacuum pump manometer and the thickness of the obtained tablet. The higher the starting pressure, the smaller the measured average thickness of the end product observed.

d) For the fourth test, microcrystalline cellulose was used as a model substance. The die 15 and the punch 14, matched to it, were used to carry out the tests. As a result of the tests, the following results were obtained:

TABLE 18
The results of tests with microcrystalline cellulose

| Outlet pressure | | Average thickness | |
|---|---|---|---|
| on the vacuum | | of the obtained | |
| pump manometer | | tablet [mm] | Observations |
| 0 MPa | | 3.91 | A positive result tablet does |
| (atmospheric | | | not disintegrate |
| pressure) | | | |
| 0.005 | MPa | 3.45 | A positive result tablet does |
| | | | not disintegrate |
| 0.01 | MPa | 3.11 | A positive result tablet does |
| | | | not disintegrate |
| 0.05 | MPa | 2.83 | A positive result tablet does |
| | | | not disintegrate |
| 0.1 | MPa | 2.47 | A positive result tablet does |
| | | | not disintegrate |
| 0.15 | MPa | 2.35 | A positive result tablet does |
| | | | not disintegrate |

The result of the experiment was the observation of the relationship between the value of the output pressure observed on the vacuum pump manometer and the thickness of the obtained tablet. The higher the starting pressure, the smaller the measured average thickness of the end product observed.

e) For the fifth test, diatomaceous earth (silica of natural origin—SiO2) was used as a model substance. The die 15 and the punch 14, matched to it, were used to carry out the tests. The obtained results are shown in Table 19.

TABLE 19
The results of tests with diatomaceous earth

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 3.89 | A negative result The tablet |
| | | | is capped or disintegrates |
| 0.01 | MPa | 3.66 | A positive result tablet does |
| | | | not disintegrate |
| 0.05 | MPa | 3.51 | A positive result tablet does |
| | | | not disintegrate |
| 0.1 | MPa | 3.38 | A positive result tablet does |
| | | | not disintegrate |
| 0.15 | MPa | 3.27 | A positive result tablet does |
| | | | not disintegrate |

As a result of the experiment, tablets were obtained from a substance that cannot be compressed under atmospheric pressure.

Another positive effect of the experiment was the observation of the relationship between the value of the output pressure observed on the vacuum pump manometer and the thickness of the obtained tablet, the effects of which confirm the observations from the first test with the first model substance (microcrystalline cellulose). The higher the starting pressure, the smaller the measured average thickness of the end product observed.

f) For the sixth test, micronized diosmin was used as a test substance. The die 15 and the punch 14, matched to it, were used to carry out the tests. The obtained results are shown in Table 20.

TABLE 20
The results of tests with micronized diosmin

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 3.79 | A negative result The tablet |
| | | | is capped or disintegrates |
| 0.01 | MPa | 3.60 | A positive result tablet does |
| | | | not disintegrate |
| 0.05 | MPa | 3.48 | A positive result tablet does |
| | | | not disintegrate |
| 0.1 | MPa | 3.39 | A positive result tablet does |
| | | | not disintegrate |
| 0.15 | MPa | 3.28 | A positive result tablet does |
| | | | not disintegrate |

As a result of the experiment, tablets were obtained from a substance that cannot be subjected to the tableting process under atmospheric pressure.

An additional positive effect of the experiment, as in the first two cases, was the observation of the relationship between the value of the output pressure observed on the vacuum pump manometer and the thickness of the obtained tablet. The higher the starting pressure, the smaller the measured average thickness of the end product observed.

g) For the seventh test, vitamin D3 precoated with hydroxyapatite in a weight ration of 1:87 plus excipients was used as a test substance. The obtained results are shown in Table 21.

TABLE 21
The results of tests with vitamin D3 precoated with hydroxyapatite
in a weight ration of 1:87 plus excipients

| Outlet pressure | | Average thickness | |
|---|---|---|---|
| on the vacuum | | of the obtained | |
| pump manometer | | tablet [mm] | Observations |
| 0 MPa | | 0 | A negative result The |
| (atmospheric | | | tableting substance does not |
| pressure) | | | form a compact product, the |
| | | | tablet disintegrates when |
| | | | ejected from the die |
| 0.005 | MPa | 8.14 | A negative result The tablet |
| | | | is capped or disintegrates |
| 0.01 | MPa | 8.10 | A positive result tablet does |
| | | | not disintegrate |
| 0.05 | MPa | 7.89 | A positive result tablet does |
| | | | not disintegrate |
| 0.1 | MPa | 7.64 | A positive result tablet does |
| | | | not disintegrate |
| 0.15 | MPa | 7.21 | A positive result tablet does |
| | | | not disintegrate |

As a result of the experiment, tablets were obtained from a mixture that cannot be subjected to the tableting process under atmospheric pressure.

An additional positive effect of the experiment, as in the first two cases, was the observation of the relationship between the value of the output pressure observed on the vacuum pump manometer and the thickness of the obtained tablet. The higher the starting pressure, the smaller the measured average thickness of the end product observed.

### REFERENCE LIST

1. Upper punch,
2. Table,
3. Vacuum pump outlet opening,
4. Die chamber,
5. Die,
6. Motor,
7. Sealed chamber with reduced pressure,
8. Hopper,
9. Vacuum pump chamber connection valve,
10. Eccentic,
11. Lower punch,
12. Connection valve of the vacuum pump chamber of the outer chamber,
13. External vacuum chamber,
14. A rotary tablet press upper punch,
15. A rotary tablet press rotary die,
16. Rotary tablet press die base,
A1—vacuum chamber upper wall,
A2—vacuum chamber bottom wall,
A3—vacuum chamber side wall,
B1—external vacuum chamber upper wall,
B2—external vacuum chamber bottom wall,
B3—external vacuum chamber side wall.

1. A method of tableting a tablet mass containing components crystallizing in a tetrahedral and/or regular arrangement and/or subjected to micronization and/or nanonization, carried out in the following steps:
a) moving the punch and/or punches,
b) filling the cavity and/or die cavity with a tablet mass,
c) lowering the punches and/or punch and compressing a tablet mass,
d) pushing the tablets and/or tablet out of the cavity,
e) pushing the tablets and/or tablet out of the die;
characterized in that in steps b) and c) the pressure in the vacuum chamber (7, 13) is lowered in the range from −0.005 MPa to −0.15 MPa, wherein the lowering of the pressure in the vacuum chamber (7, 13) reduces the pressure in the tablet press die cavity.

2. The method according to claim 1 characterized in that in steps b) and c) the pressure in the external vacuum chamber (13) is reduced.

3. The method according to claim 1, characterized in that the tablet press is selected from the group comprising: a single-punch tablet press or a rotary tablet press.

4. The method according to claim 1 characterized in that the tablet mass is selected from the group comprising: polysaccharide, preferably microcrystalline microcellulose, naturally derived silica, preferably diatomaceous earth, crystalline active substance, preferably diosmin or micronized diosmin, a vitamin preparation, preferably vitamin D3 coated with hydroxyapatite.

5. The method according to claim 1, characterized in that the tablets have a thickness from 2.2 mm to 8.1 mm.

6. The method according to claim 1, characterized in that the pressure is reduced from −0.01 MPa to −0.15 MPa.

7. A tablet mass tableting device comprising a housing and a tableting mechanism, wherein the housing has a bottom wall, a top wall and four side walls that are connected to each other to form a sealed vacuum chamber, and the tableting mechanism is housed in the chamber housing, characterized in that a valve for connecting the vacuum pump (9, 12) is provided on the side wall (A3, B3) of the vacuum chamber (9, 12).

8. The device according to claim 7, characterized in that the tableting mechanism is a single-punch tablet press or a rotary tablet press.

9. The device according to claim 7, characterized in that the vacuum chamber (7) comprises a single-punch tablet press having a lower punch table (2) on which a lower punch (11) is placed, the chamber (7) and the tablet press die (5), wherein the die (5) is placed on top of the lower punch (11) and includes a die cavity (4) for introducing the upper punch (1) in order to introduce the tablet mass therein and to receive the upper punch (1).

10. The device according to claim 7, characterized in that the top wall (A1) of the vacuum chamber (7) comprises a die (5) of a single-punch tablet press.

11. The device according to claim 7, characterized in that the chamber (7) with the tableting mechanism, which is a single-punch tablet press, is placed in an external vacuum chamber which includes a vacuum valve (12) for connecting a vacuum pump.

12. The device according to claim 7, characterized in that the external vacuum chamber (13) comprises a rotary tablet press having a rotary tablet press base (16) placed on the bottom wall (B2) of the vacuum chamber (13), connected to a drive motor (6), and connected with the table via the rotary tablet press die (15), above which there is the upper punch (14) of the rotary tablet press.

13. A kit comprising a tablet mass tableting device as defined in claim 7 and a vacuum pump that is connected to the device via the vacuum valve (3).

14. The kit according to claim 13, characterized in that the device is placed in the external vacuum chamber (13) and a vacuum pump is connected to the external chamber (13) via the vacuum valve (12).
